(19) United States
(12) Patent Application Publication
(10) Pub. No.: US 2004/0007528 A1
(43) Pub. Date: Jan. 15, 2004

(54) Intertwined, free-standing carbon nanotube mesh for use as separation, concentration, and/or filtration medium

(75) Inventors: Olgica Bakajin, San Leandro, CA (US); Aleksandr Noy, Belmont, CA (US)

Correspondence Address: James S. Tak, Assistant Laboratory Counsel, Lawrence Livermore National Laboratory, P.O. Box 808, L-703, Livermore, CA, 94551, US

(73) Assignee: The Regents of the University of California

(21) Appl. No.: 10/613,962

(22) Filed: Jul. 3, 2003

Related U.S. Application Data
(60) Provisional application No. 60/393,444, filed on Jul. 3, 2002.

(51) Int. Cl. B01D 61/14

(52) U.S. Cl. 210/650; 210/656; 210/660; 210/321.87; 210/490

(57) ABSTRACT

A carbon nanotube mesh for separating, concentrating, and/or filtering molecules, and a method for fabricating the same. The carbon nanotube mesh includes a plurality of intertwined free-standing carbon nanotubes which are fixedly attached to a substrate. In one embodiment, the microdevice is fabricated by growing the intertwined free-standing carbon nanotubes to extend by free growth from the surface of the substrate into free space.

### I. CLAIM OF PRIORITY IN. PROVISIONAL APPLICATION

This application claims priority in provisional application filed on Jul. 3, 2002, entitled “Use of Free Standing Carbon Nanotubes Arrays as Separation and Concentration Medium” serial No. 60/393,444, by inventors Bakajin et al.

The United States Government has rights in this invention pursuant to Contract No. W-7405-ENG-48 between the United States Department of Energy and the University of California for the operation of Lawrence Livermore National Laboratory.

### II. FIELD OF THE INVENTION

The present invention relates to molecular and chromatographic separation mediums, and more particularly to an apparatus and fabrication method for free, standing nanotube arrays used as mediums for separation, concentration, or filtration.

### III. BACKGROUND OF THE INVENTION

Chromatographic separations encompass a variety of separation methods adaptable for different classes of compounds. Chromatography relies on differential partitioning between a flowing mobile phase and a stationary phase to separate the components in a mixture: sample components that partition strongly into the stationary phase are retarded more and thus are separated from components that stay predominantly in the mobile phase and exit the separation device earlier.

Examples of chromatography techniques include: gas chromatography (GC) that is used for separation of small volatile organic compounds (including chemical warfare agents); high pressure liquid chromatography (HPLC) that is a common method for separation of organic compounds in liquid phase; reverse phase HPLC that is particularly relevant for protein separation; and the size exclusion chromatography (SEC) that separates biomolecules based on their size and shape. In GC separation of different molecules occurs due to the varying degree of adsorption of the molecules in the gas phase on the solid stationary phase. RP HPLC relies on using two component mobile phase and hydrophobic surfaces. One of the components of the mobile phase is water, which does not interact with the hydrophobic adsorbent surface and therefore does not compete with the analyte for the adsorption sites. The other component of the mobile phase is usually an organic solvent, is “the modifier” which can interact with the adsorbent surface and compete with analyte molecules for the adsorption sites. Increasing the concentration of the “modifier” mobile phase leads to the decreasing of the analytes retention. Therefore, passing a gradient of modifier concentration through the column will lead to a gradual removal and separation of the analyte based on the retention strength. And SEC relies on pathway-dependent velocity distribution in a column packed with porous packing material. Flow through the pores is much slower than the flow around the particles. Smaller molecules can enter the pores; therefore their average migration speed is small. The bigger molecules experience steric hindrance in permeation inside the packing pore space and move through the column primarily around the particles with fastest possible speed. As a result the biggest molecules come out of the column first, and the smallest ones come out last.

While all of these techniques are based on different physical mechanisms, they share several common characteristics, including (1) requiring a porous medium; (2) highly influenced by the pore size distribution and surface chemistry of the separation medium; and requiring high surface-to-volume ratio for efficient separation. Prior art examples of currently used separation media include packed beds of porous beads, columns packed with gels of various porosity, columns packed with porous high surface energy materials (such as activated silica).

There is a therefore a need for a medium for separation, concentration, or filtration having a high surface-to-volume ratio, surface properties suitable for surface functionalization, robust mechanical strength and elastic properties, chemically inert properties for use with a variety of compounds, and easily patternable to facilitate use in devices requiring miniaturization and integration.

### IV. SUMMARY OF THE INVENTION

One aspect of the present invention includes a carbon nanotube mesh comprising: a plurality of intertwined free-standing carbon nanotubes fixedly attached to a substrate for separating, concentrating, and/or filtering molecules flowed through said mesh.

Another aspect of the present invention includes a method of fabricating a carbon nanotube mesh, comprising: growing a plurality set of intertwined free-standing carbon nanotubes fixedly attached to a substrate, wherein said plurality set of carbon nanotubes is capable of separating, concentrating, and/or filtering molecules flowed therethrough.

And another aspect of the present invention includes a method of separating, concentrating, and/or filtering molecules comprising: flowing said molecules into a carbon nanotube mesh comprising a plurality of intertwined free-standing carbon nanotubes fixedly attached to a substrate, whereby said carbon nanotube mesh operates as an active medium for separating, concentrating, and/or filtering said molecules.

### V. BRIEF DESCRIPTION OF THE DRAWINGS

The accompanying drawings, which are incorporated into and form a part of the disclosure, are as follows:

FIG. 1A is a schematic cross-sectional view of a first exemplary embodiment of the present invention showing a deposition stage of fabrication.

FIG. 1B is a schematic cross-sectional view of the first exemplary embodiment following FIG. 1A, showing an oxidation stage of fabrication.

FIG. 1C is a schematic cross-sectional view of the first exemplary embodiment following FIG. 1B, showing a growth stage of fabrication.

### VI. DETAILED DESCRIPTION

The present invention is directed to an intertwined free-standing carbon nanotube mesh grown on a substrate, for use as a separation, concentration, and/or filtration medium, as well a method of fabrication and use. The mesh provides any one or more or all of separation, concentration, and/or filtering functions with respect to molecules and analytes present in a fluid flow (i.e. gas or liquid flow). The unique properties of carbon nanotubes, such as its small, tunable dimensions, e.g. pore size, a large surface-to-volume ratio (greater than packed bead columns), modifiable surface properties, etc., provide many advantages when used for separation and concentration functions in various separation or chromatographic applications. The present invention utilizes these unique properties of carbon nanotubes by growing a plurality of intertwined free-standing carbon nanotubes to attach to a substrate for use in such applications. It is notable that separation, concentration, and filtration operations are related if not similar operations involving the discrimination and/or selection of molecules based on a molecular property or properties, such as structural properties of size, weight, etc., chemical properties, e.g. hydrophilic, hydrophobic, etc., and even electrical properties having positive or negative charge. It is appreciated, however, that concentration and filtration further suggest that particles, i.e. molecules, are selectively retained after being separated. In this regard, and depending on the application the mesh of the present invention may actively operate to achieve any one or more or all of these functions, without being limited to any one.

While various fabrication methods may be employed for fabricating the mesh of the present invention, the preferred fabrication method of the present invention uses chemical vapor deposition (CVD) employing a CVD growth catalyst. And preferably the catalyst for use in a CVD growth process nanotube growth is metallic iron (Fe). Applicants have been able to demonstrate that iron colloids supported on alumina nanoparticles, iron colloids alone, and thin layers of iron all lead to sufficient nanotube growth. In all cases, a high-temperature CVD reactor is utilized to effect pyrolysis of a reactant mixture, with the carbon nanotubes being grown by passing the hydrocarbon pyrolysis products over the iron catalyst. For a thin film iron layer of about 5 nanometers, a mixture of ethylene, hydrogen, and argon may be pyrolized at about 800-850 degrees Celsius. The surfaces of the nanotube mesh may also be functionalized to select/discriminate molecules as required by the application.

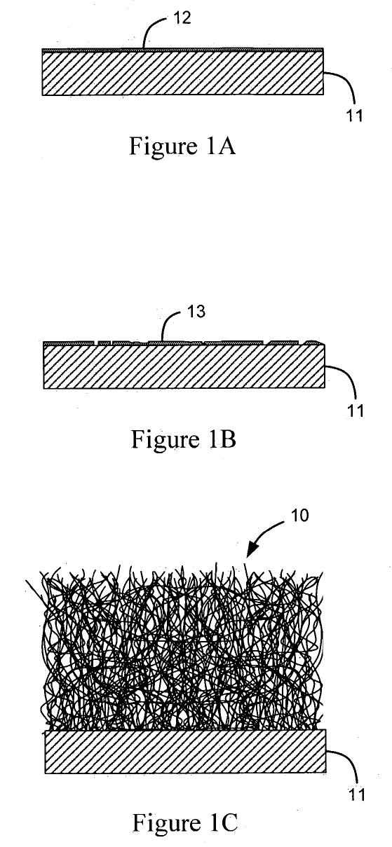

Turning now to the drawings, FIGS. 1A-C show the fabrication of an exemplary embodiment of the mesh, generally indicated at reference character 10 (in FIG. 1C) using a CVD growth process. As shown in FIG. 1A, a substrate 11 is provided such as silicon, fused silica or other patternable material. It is appreciated that the substrate surface may have any suitable contour or geometry. Next a layer of iron catalyst 12 is deposited in the channel 11. The layer of iron catalyst is preferably a thin film layer having a thickness of about 5 nanometers, and deposited using thin film deposition techniques, such as evaporation or sputtering, with lithographic masking. It is appreciated, that as an alternative to an iron layer, colloidal iron nanoparticles and iron nanoparticles supported on the fumed alumina surface may be utilized to grow carbon nanotubes as well.

FIG. 1B next shows the deposited layer of FIG. 1A converted into iron oxide 13 by heating the substrate in an oxygen furnace (not shown), such as at 300 degrees Celsius for about 5 hours. The iron oxide is then reduced back into metallic iron by heating it in the hydrogen-rich atmosphere.

As shown in FIG. 1C, carbon nanotubes are then grown on the substrate to produce an intertwined free-standing carbon nanotube mesh 10. The mesh is produced by passing products of hydrocarbon pyrolysis over the catalyst surface at elevated temperatures, e.g. above ______. Structural mesh parameters of height, density, and pore size are regulated mostly by the density and size parameters of the nanotubes. Both of these parameters are controllable by changing gas flows, flow ratios, and catalyst thickness. The grown carbon nanotube mesh 14 has pores of variable and tunable size on the order of 10-200 nanometers. The resulting mesh is stable in a variety of organic solvents and in air due to the nanotubes being chemically inert, and resists ultrasonication very well. Furthermore, carbon nanotube elements possess unique mechanical strength and elasticity which makes the mesh highly robust.

It is notable that because the carbon nanotubes consist of a mesh of the carbon nanotubes grown directly from a solid or porous support of the substrate surface, they are free-standing features supported by the substrate. Moreover, the nanotubes extend randomly from this support into free space, characteristic of a free-grown structure, to form a dense intertwined and entangled mesh. Carbon nanotube meshs can be grown in this fashion over extended macroscopic surfaces, on lithographically defined microscale areas and inside microfabricated structures, such as a microfluidic channel. Moreover, the carbon nanotubes produced in this manner conforms to the shape of the microfluidic channel as shown in the figures. Since Fe catalyst can be easily patterned using standard lithographic techniques, nanotube meshs are easily patternable for applications that require miniaturization and integration of devices, such as for specific parts of a microfabricated device. Carbon nanotube meshs may be tuned to a particular application since it is possible to control nanotube size, density and orientation in the growth process.

Additionally, the carbon nanotube mesh of the present invention may be further customized by functionalizing the surface properties of the nanotubes to select and/or discriminate molecules. Surface functionalization may be achieved, for example, by applying different nanotube coatings and derivatizations of specific chemical groups. The coatings may be polymers or small molecules that either incorporate particular chemical functionality or facilitate the chemical attachment of a functionality.

While operation of the carbon nanotube mesh of the present invention may be intended for separation applications, such as electrophoretic separtion, it is not limited only to such. The present invention may be utilized with pressure driven flow for other applications, such as, but not limited to: size exclusion chromatography (filtering); use as chromatography media (gas or liquid) by exploiting the different sticking probability of different chemical species to surfaces of bare nanotubes and modified nanotubes; and as concentrators for concentrating species by accumulating them either at the front boundary or just along the nanotube element, and subsequently releasing the collected species by changing environmental conditions to recover concentrated substrate. CNT as a patternable separation medium, therefore, may be utilized for various applications. Example applications, include but not limited to: gas chromatography, size exclusion liquid chromatography in a solvent that wets carbon nanotubes, filtering and concentration, possible HPLC-type separation or selective adsorption for molecules that have natural affinity to the aromatic graphite-like structure of nanotubes (dioxins are just one example). Furthermore, derivatized carbon nanotube mesh may be utilized, for example, for more targeted gas chromatography; size exclusion liquid chromatography in a water based solvent; filtering and concentration; separation of proteins (similar to RP HPLC); and DNA separations via electrophoresys.

While particular operational sequences, materials, temperatures, parameters, and particular embodiments have been described and or illustrated, such are not intended to be limiting. Modifications and changes may become apparent to those skilled in the art, and it is intended that the invention be limited only by the scope of the appended claims.

We claim:

1. A carbon nanotube mesh comprising:
a plurality of intertwined free-standing carbon nanotubes fixedly attached to a substrate for separating, concentrating, and/or filtering molecules flowed through said mesh.

2. The carbon nanotube mesh of claim 1,
wherein said carbon nanotubes extend randomly into free space from said substrate characteristic of free-growth structures.

3. The carbon nanotube mesh of claim 1,
wherein the surfaces of said carbon nanotubes are functionalized to chemically select/discriminate molecules.

4. The carbon nanotube mesh of claim 3,
wherein the surfaces of said carbon nanotubes are functionalized with a nanotube coating.

5. The carbon nanotube mesh of claim 4,
wherein the nanotube coating comprises a chemical derivatization.

6. The carbon nanotube mesh of claim 1,
wherein said carbon nanotube mesh has pore sizes of 10 to 200 nanometers.

7. A method of fabricating a carbon nanotube mesh, comprising:
growing a plurality of intertwined free-standing carbon nanotubes on a substrate to produce the carbon nanotube mesh fixedly attached thereto and capable of separating, concentrating, and/or filtering molecules flowed through said carbon nanotube mesh.

8. The method of claim 7,
wherein said carbon nanotubes are free-grown to extend randomly from the surface of said substrate into free space.

9. The method of claim 5,
further comprising functionalizing the surfaces of said carbon nanotubes to chemically select/discriminate molecules.

10. The method of claim 9,
wherein the surfaces of said carbon nanotubes are functionalized by applying a nanotube coating having the desired functionality.

11. The method of claim 10,
wherein the nanotube coating comprises a chemical derivatization.

12. The method of claim 7,
wherein said carbon nanotube mesh has pore sizes of 10 to 200 nanometers.

13. The method of claim 7,
further comprising depositing a CVD growth catalyst on said substrate and utilizing a CVD growth process to grow said carbon nanotube mesh.

14. The method of claim 13,
wherein the CVD growth process includes pyrolysis of a mixture of ethylene, hydrogen, and argon at 850 degrees Celsius.

15. The method of claim 14,
wherein the CVD growth catalyst is iron.

16. The method of claim 15,
wherein the iron catalyst is deposited as a thin film.

17. The method of claim 16,
wherein the thin film iron catalyst has a thickness of about 5 nanometers.

18. A carbon nanotube mesh produced according to the method of claim 7.

19. A method of separating, concentrating, and/or filtering molecules comprising:
flowing said molecules into a carbon nanotube mesh comprising a plurality of intertwined free-standing carbon nanotubes fixedly attached to a substrate, whereby said carbon nanotube mesh operates as an active medium for separating, concentrating, and/or filtering said molecules.

20. The method of claim 19,
wherein the flow into the carbon nanotube mesh is a pressure driven flow.
